(19) United States
(12) Patent Application Publication
(10) Pub. No.: US 2017/0196251 A1
(43) Pub. Date: Jul. 13, 2017

(54) Device for separating the meat and the shell of a nut

(71) Applicant: Remi FREGEAT, GLANES (FR)

(72) Inventor: Remi FREGEAT, GLANES (FR)

(21) Appl. No.: 15/400,448

(22) Filed: Jan. 6, 2017

(30) Foreign Application Priority Data
Jan. 7, 2016 (FR) 1650125

(51) Int. Cl. A23N 5/00

(52) U.S. Cl. CPC A23N 5/00

(57) ABSTRACT

Disclosed is a device for separating the meat and the shell of a nut including a stator (10) and a rotor (12), both having a shape for rotation around a longitudinal axis XX′, a work space, defined between the stator and the rotor, varying radially, and at least one unit for compressing the nut between the stator (10) and the rotor (12).

This invention relates to a device for separating the meat and the shell of a nut. In the field of agricultural production and more particularly the production of ready-to-consume nuts, the market wishes to be able to offer nuts in the form of ready-to-eat meats, i.e., separated from their shells or husks. The nuts can also be used for culinary purposes and have to be separated from their shells, ready to be used.

The shell is a rigid casing and non-edible in food terms; the meat that is contained and protected by the shell is more tender and more fragile.

Within the framework of the production of walnuts, for example, this stage is referred to as shelling. This stage is primarily done by hand to make it possible to extract the meat without running the risk of damaging it. Actually, the separation of the meat and its shell is done by breaking the shell to extract the meat therefrom. The whole problem lies in the fact that it is necessary to crush the nut with enough force to break the shell but with a moderate force that makes it possible to preserve the meat.

It must be possible to automate the method for extracting the meat from its shell without running the risk of creating bulk and congestion that could be induced by the accumulation of broken shells and causing a malfunction. It is therefore necessary to provide a separation of the meats and a simultaneous removal that does not damage the meat. It should be noted that in the case of walnuts, the convolutions of the meat and the shell make separation difficult.

This invention is described according to a main embodiment and its variants relative to the associated drawings in which the different figures show:

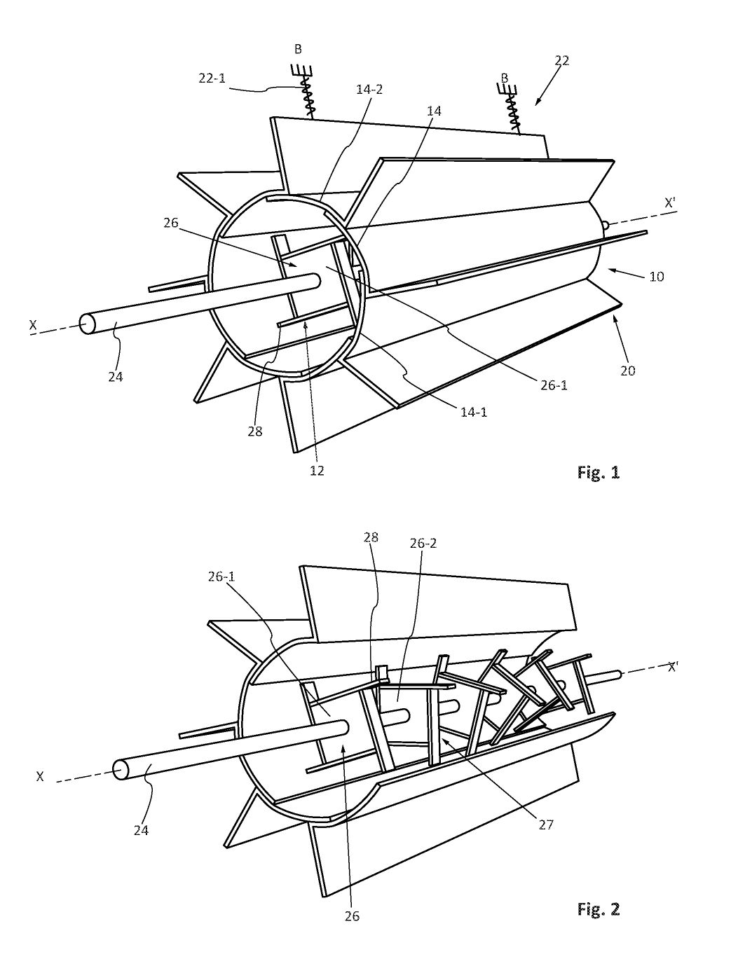

FIG. 1: a perspective view of the device,

FIG. 2: a perspective view of the rotor of the device of FIG. 1,

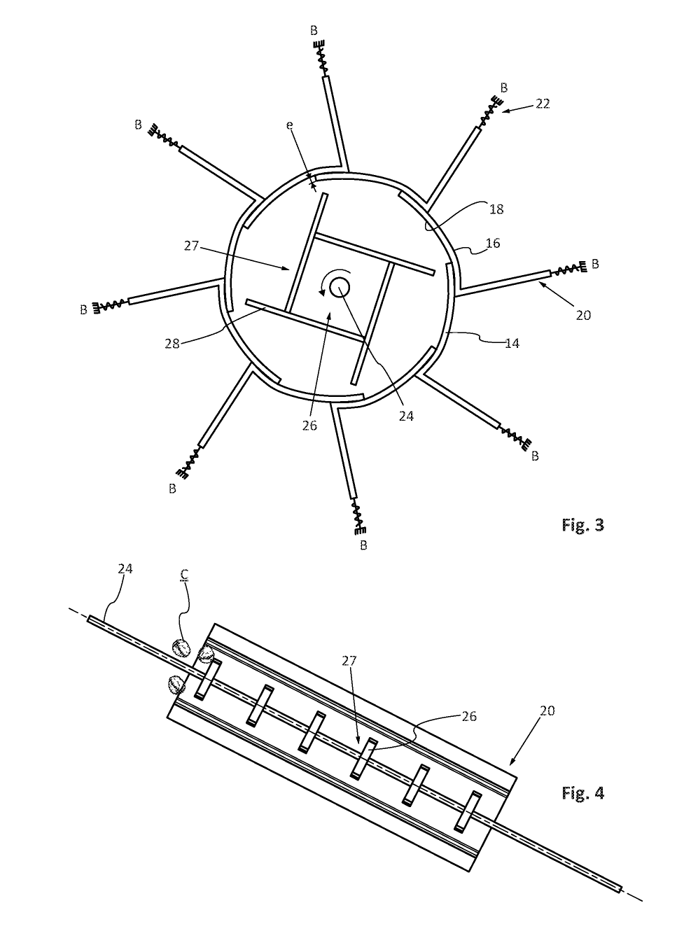

FIG. 3: a front view of the device of FIG. 1,

FIG. 4: a view of the tilted device while in operation,

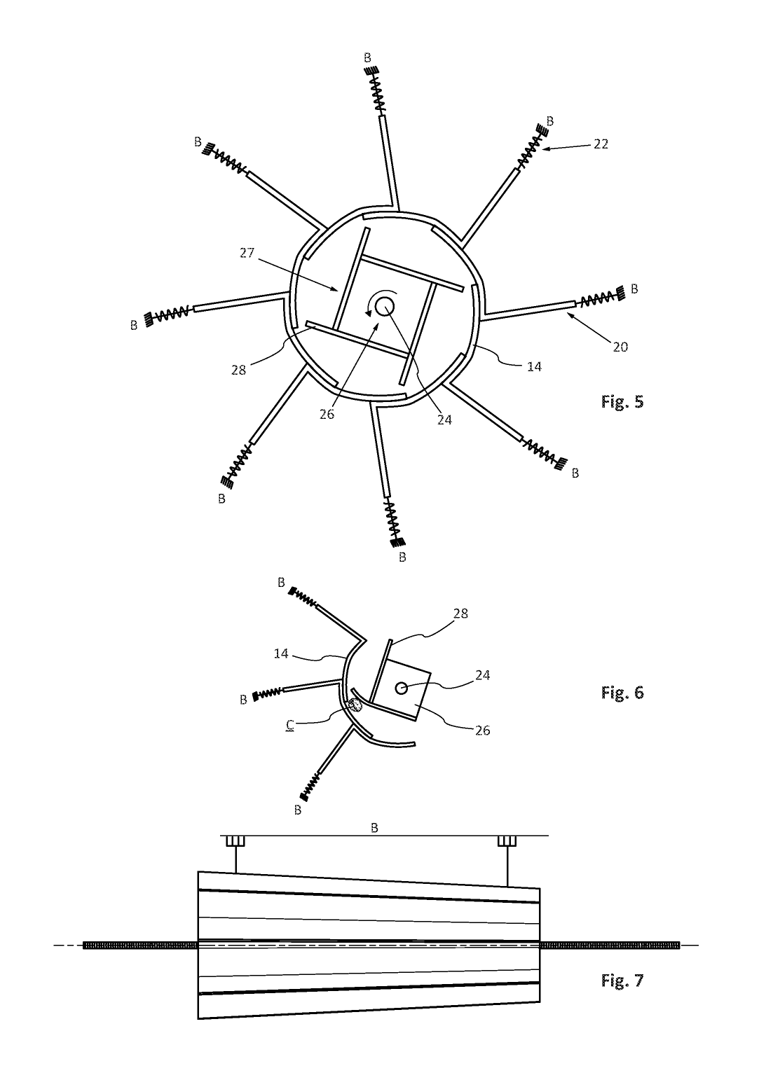

FIG. 5: a front view of a reduced-diameter configuration of FIG. 3,

FIG. 6: a front view of a compressed nut,

FIG. 7: a lateral elevation view of a configuration that is conical in shape.

FIGS. 1, 2 and 3 show the device, comprising a stator 10 and a rotor 12 located in the stator 10.

The stator 10 has a shape for rotation around a longitudinal axis XX′.

The stator 10 comprises sectors 14-1 . . . 14-n with curved shapes. Each sector 14 has a curved shape over its entire length, whose concavity is oriented toward the interior of the shape for rotation.

The sectors 14 are partially superposed, just like roof tiles or scales, longitudinally and along their length, parallel to the axis XX′. In the counterclockwise direction, according to the embodiment, it is noted that the sectors 14 have a first part 16 that is outside of the shape for rotation that partially covers the preceding sector 14-1 and a second part 18 that is inside of the shape for rotation that is covered by the next sector 14-2. This superposition generates a “step” of a height that is approximately equal to the thickness of the sector.

This arrangement is particularly visible in FIG. 3.

Each sector 14 is equipped with a rigid support 20-1 . . . 20-n attached longitudinally to the outside surface 16 of said sector 14. Each rigid support 20 is mounted on a radial adjustment means 22-1 . . . 22-n in relation to a stationary frame B. Each radial adjustment means 22-1 . . . 22-n comprises, in the embodiment shown, at least one screw-nut assembly, in this case two assemblies, an upstream assembly 22-1F . . . 22-1R and a downstream assembly 22-nF . . . 22-nR.

The rotor 12 has a rotational profile, and for its rotational axis, it has the axis XX′. Said rotor 12 comprises a central shaft 24 that is coaxial to the axis XX′.

In the embodiment shown, the shaft 24 carries supports 26-1 . . . 26-n arranged in a monolithic way or separated from one another. In this case, each support 26 has a square cross-section centered on the axis XX′ and is offset angularly, by approximately 30°. Each of said supports 26 can be adjusted angularly on the axis XX′. These adjustments make it possible to adjust the offsets from one support 26 to the next.

Compression means 27, attached to each support 26, are connected to the faces of said support 26. In a preferred embodiment, the compression means are thin strips 28 that are attached to each support 26 with a square cross-section and are therefore off-axis in relation to the axis XX′.

These thin strips 28 are made of a flexible material and have a certain flexibility allowing a deformation while making possible compression on the nuts C, without spoiling the nut C.

A work space is defined between the sectors 14 and the end of the thin strips 28. This work space varies radially between a defined distanced between the end of each thin strip 28 and the step and a defined distance D between the end of each thin strip and the sector following immediately after said step.

The operation of the device that was just described is explained with regard to FIG. 4.

A nut C is placed at the inlet of the device, with the given example being a walnut.

This nut C was preferably broken and/or embrittled by an impact or scoring on the shell.

The shaft 24 is rotated by any motor means that is suitable and is not shown.

The supports 26 of the thin strips 28 are driven in rotation. The nut C is rolled by the thin strips 28 along the inside wall that consists of the sectors 14. The thin strips 28 simultaneously exert pressure on the fragile or embrittled shell. This pressure varies because of the variation in distance between the thin strips 28 and said inside wall of the stator 10. The pressure exerted is all the more significant as the distance is reduced.

The device, comprising multiple supports 26 each equipped with multiple compression means, more particularly the thin strips 28, makes it possible to carry out multiple gradual and successive compressions on the same meat and simultaneously on the various other nuts C. The shells of these nuts C ultimately separate and release the meat.

The sizes of these shell pieces and halves or pieces of halves are then less than the distance d. Since the device is positioned in a tilted manner, as shown in FIG. 4, the nuts C advance along the axis XX′ by gravity and rolling even though these pieces accumulate by gravity in the lower part of the stator 10 and are removed.

The same holds true for separated meats and shells that are removed in the low part of the device and then separated by any sorting means, for example sieving and/or blowing.

FIG. 5 shows the reduced-diameter device.

The average distance between the end of the thin strips 28 and the sectors 14 is selected based on the sizes of the nuts to be processed, i.e., their diameters, of several centimeters to provide an order of magnitude.

FIG. 6 shows a nut in compression between a sector 14 and a thin strip 28. It is possible to note the influence of the sectors that allow the thin strips to have a good action of rolling and compressing the nut C.

FIG. 7 shows a variant of the device. The stator 10 around the longitudinal axis XX′ has a conical shape for rotation so that the crushing of the nuts is done in a manner that increases as the nuts move in the stator, from top to bottom.

A variant of the device, not shown, offers means for variation of the work space, either by adjusting the dimensions of said rotor 12 or by integral changing of the rotor 12. These two possibilities thus make possible the adaptation of the distance between the end of the crushing means 27 and the wall of the stator 10.

A variant of the device, not shown, provides the possibility of reversing the stator 10 and the rotor 12 as defined above, with the stator 10 becoming movable in rotation and the rotor 12 becoming stationary.

According to another simplified variant, the steps can be provided by a cylindrical, smooth inside wall on which wire radial bulges are located.

According to another variant, the thin strips 28 can be replaced by pins with round or oval cross-sections.

According to yet another variant, an accessory in the shape of a truncated cone, equipped on the periphery with radial fins and inserted on the axis XX′ so as to break the possible shells that may have withstood the preceding actions of the compression means.

1. Device for separating the meat and the shell of a nut comprising a stator (10) and a rotor (12), both having a shape for rotation around a longitudinal axis XX′, with a work space being defined between the stator (10) and the rotor (12), varying radially, wherein the longitudinal axis XX′ is tilted and wherein the device comprises at least one means (27) for compressing the nut between the stator (10) and the rotor (12).

2. Device for separating the meat and the shell of a nut according to claim 1, wherein the stator (10) comprises at least two sectors (14) of curved shape, whose concavity is oriented toward the inside.

3. Device for separating the meat and the shell of a nut according to claim 2, wherein the sectors (14) are partially superposed.

4. Device for separating the meat and the shell of a nut according to claim 2, wherein the sectors (14) comprise rigid supports (20-1 . . . 20-n) that are attached longitudinally to the outside surface (16) of each of said sectors (14).

5. Device for separating the meat and the shell of a nut according to claim 4, wherein the rigid supports (20-1 . . . 20-n) are equipped with radial adjustment means (22-1 . . . 22-n).

6. Device for separating the meat and the shell of a nut according to claim 1, wherein the rotor (12) comprises at least one shaft (24) comprising at least one support (26).

7. Device for separating the meat and the shell of a nut according to claim 6, wherein the support (26) comprises at least one thin strip (28).

8. Device for separating the meat and the shell of a nut according to claim 1, wherein the shape for rotation around the longitudinal axis XX′ is a conical shape for rotation.

9. Device for separating the meat and the shell of a nut according to claim 1, wherein the stator (10) becomes movable in rotation, and the rotor (12) becomes stationary.

10. Device for separating the meat and the shell of a nut according to claim 3, wherein the sectors (14) comprise rigid supports (20-1 . . . 20-n) that are attached longitudinally to the outside surface (16) of each of said sectors (14).

11. Device for separating the meat and the shell of a nut according to claim 2, wherein the rotor (12) comprises at least one shaft (24) comprising at least one support (26).

12. Device for separating the meat and the shell of a nut according to claim 3, wherein the rotor (12) comprises at least one shaft (24) comprising at least one support (26).

13. Device for separating the meat and the shell of a nut according to claim 4, wherein the rotor (12) comprises at least one shaft (24) comprising at least one support (26).

14. Device for separating the meat and the shell of a nut according to claim 5, wherein the rotor (12) comprises at least one shaft (24) comprising at least one support (26).

15. Device for separating the meat and the shell of a nut according to claim 2, wherein the shape for rotation around the longitudinal axis XX′ is a conical shape for rotation.

16. Device for separating the meat and the shell of a nut according to claim 3, wherein the shape for rotation around the longitudinal axis XX′ is a conical shape for rotation.

17. Device for separating the meat and the shell of a nut according to claim 4, wherein the shape for rotation around the longitudinal axis XX′ is a conical shape for rotation.

18. Device for separating the meat and the shell of a nut according to claim 5, wherein the shape for rotation around the longitudinal axis XX′ is a conical shape for rotation.

19. Device for separating the meat and the shell of a nut according to claim 6, wherein the shape for rotation around the longitudinal axis XX′ is a conical shape for rotation.

20. Device for separating the meat and the shell of a nut according to claim 7, wherein the shape for rotation around the longitudinal axis XX′ is a conical shape for rotation.
